(19) United States
(12) Patent Application Publication
(10) Pub. No.: US 2022/0232892 A1
(43) Pub. Date: Jul. 28, 2022

(54) INHALER AND REPLACEABLE LIQUID RESERVOIR FOR AN INHALER

(71) Applicant: HAUNI MASCHINENBAU GMBH, HAMBURG (DE)

(72) Inventors: BJÖRN SCHLÜTER, BARGTEHEIDE (DE); CAMERON JOHN WAGENKNECHT, HAMBURG (DE)

(21) Appl. No.: 17/615,481

(22) PCT Filed: Jun. 23, 2020
(86) PCT No.: PCT/EP2020/067434

§ 371 Date: Nov. 30, 2021

(30) Foreign Application Priority Data
Jun. 27, 2019 (DE) 102019117379.5

(51) Int. Cl. A24F 40/42; A24F 40/10; A24F 40/44

(52) U.S. Cl. CPC A24F 40/42; A24F 40/44; A24F 40/10

(57) ABSTRACT

Inhaler, comprising a vaporizer device with at least one electric vaporizer for vaporizing liquid supplied to the vaporizer, at least one electrical line for an electrical voltage supply to the vaporizer, and a receptacle for retaining a replaceable liquid reservoir which is fluidically connectable to the vaporizer via an opening, wherein the receptacle comprises a device which forces the replaceable liquid reservoir with the opening into direct abutment with the vaporizer.

The present invention relates to an inhaler having the features of the preamble of claim 1 and to a replaceable liquid reservoir for an inhaler having the features of the preamble of claim 7.

Such inhalers with a receptacle for a replaceable liquid reservoir are known, for example, as electronic cigarette products.

The inhalers comprise a vaporizer device with at least one electric vaporizer for vaporizing liquid supplied to the vaporizer, at least one electrical line for supplying the vaporizer with electric current, and a receptacle for retaining a replaceable liquid reservoir which can be fluidically connected to the vaporizer via an opening.

Conventional electronic cigarette products or inhalers comprise a vaporizer device based, for example, on wick-coil technology, in which the liquid is transported by capillary forces from the liquid reservoir along a wick until the liquid is heated by an electrically heatable coil and thus vaporized. The wick serves as a liquid-conducting connection between the liquid reservoir and the heating coil, which serves as the vaporizer.

One disadvantage of wick-coil technology is that a lack of liquid supply leads to local overheating, which can produce pollutants. This so-called “dry puff” must be avoided. In addition, such vaporizer devices are often leaky due to the manufacturing process, so that liquid can escape in undesirable ways, for example via the air supply and/or vapor discharge.

To avoid the problems of wick-coil technology, DE 10 2017 111 119 A1 describes a vaporizer device with a vaporizer in which liquid is transported from the liquid reservoir by a wick structure to an inlet side of the vaporizer by capillary forces. The vaporizer vaporizes the liquid, and the vaporized liquid can be added to an air stream as a vapor and/or aerosol. The vaporizer is electrically connectable to an energy storage device via an electrical line for the supply of electrical energy.

In this context, the invention is based on the task of providing an inhaler and a replaceable liquid reservoir for an inhaler, in which unintentional escape of the liquid is reliably prevented, or is reduced to the lowest possible level.

The invention solves the task with the features of the independent claims.

According to claim 1, for solving the task an inhaler comprising a vaporizer device with at least one electric vaporizer for vaporizing liquid supplied to the vaporizer, at least one electrical line to an electrical voltage supply of the vaporizer, and a receptacle for retaining a replaceable liquid reservoir, which is fluidically connectable to the vaporizer via an opening, is proposed, wherein according to the basic idea of the invention it is proposed that the receptacle comprises means which force the replaceable liquid reservoir with the opening into direct abutment with the vaporizer.

With the proposed solution, the liquid reservoir with the opening is in direct contact with the vaporizer without a formation of a gap, and the liquid inevitably exits through the vaporizer when exiting the liquid reservoir. Further, when the liquid exits, the liquid is directly vaporized in the vaporizer, so that the vaporization is realized with a very good overall efficiency and the lowest possible losses.

It is further proposed that a seal sealing the opening to the outside is provided between the vaporizer and the liquid reservoir. The provided seal can further reduce the likelihood of accidental leakage of the liquid from the vaporizer device without passing through the vaporizer in the process. In this regard, the seal encloses the contact area between the vaporizer device and the opening of the liquid reservoir through which the liquid passes from the liquid reservoir into the vaporizer device, such that the seal prevents lateral escape of the liquid or vapor at the surface from the vaporizer device. In this regard, the seal may be provided on both the liquid reservoir and the vaporizer. However, an arrangement on the liquid reservoir has the advantage that it is immediately replaced with a new seal when the liquid reservoir is changed.

In this context, the device can preferably comprise a clamping device actuated by magnetic force, which enables reversible release and replacement of the liquid reservoir, in particular without the use of a tool.

Further, the device may alternatively or also additionally comprise a spring-loaded pressing piece which is spring-loaded in the direction such that it forces the replaceable liquid reservoir against the vaporizer.

It is further proposed that the pressing piece is spring-loaded in the direction of an intended flow direction in the inhaler. The intended direction of flow is defined by the flow of air caused in the inhaler when the consumer draws on the mouthpiece according to the intended use, thereby creating a negative pressure in the inhaler. Due to the proposed direction of the spring loading, it is in the same direction as the pressure gradient generated during drawing, so that the pressure force acting between the liquid reservoir and the vaporizer during drawing can be increased and the tendency of the liquid reservoir to detach from the vaporizer can be counteracted.

It is further proposed that the pressing piece is spring-loaded point-symmetrically with respect to its longitudinal axis. Due to the point-symmetrical spring loading, the liquid reservoir is forced against the vaporizer with a compressive force that is distributed as uniformly as possible over the circumference.

Further, to solve the problem according to claim 7, a replaceable liquid reservoir for an inhaler with a hollow space, which is filled with at least one liquid and is releasable via an opening, and a wick structure for transporting the liquid out of the hollow space, is proposed, in which the opening is enclosed by a seal, and is closed via a foil bonded to the seal.

The proposed solution can reduce or prevent accidental leakage of the liquid both before the liquid reservoir is inserted into the inhaler and when the liquid reservoir is inserted. In this regard, the seal is specifically used, prior to insertion, for bonding the foil sealing the opening and, in the inserted state, for sealing the contact zone between the opening of the liquid reservoir and the vaporizer.

It is further proposed that the wick structure in the liquid reservoir is formed by a sponge filling at least the opening. The sponge forms a wick through its capillaries, which causes the liquid to be conveyed from the hollow space through the opening towards the vaporizer, wherein the sponge enables the liquid to be supplied independently of the position and orientation of the inhaler by the regularly repeated filling of the capillary and the liquid to be completely emptied from the hollow space.

This also allows the sponge to completely fill the hollow space so that the liquid is stored exclusively in the capillaries. In addition, this allows a low pressure to be applied to the sponge in the inserted state via the abutting vaporizer, without allowing the sponge to escape into the hollow space. Through this pressure, the liquid can again be actively sucked in similar to the principle of felt pens, wherein the liquid is safely stored in the sponge in the case that no pressure is exerted.

This exertion of pressure can be effected by drawing on the inhaler or also by a spring-loaded receptacle in the inhaler.

Further, the sponge may preferably be flexible in itself so that it can adjust slightly to the geometry and irregularities of a mating surface such as a vaporizer when inserted into a vaporizer device. This can avoid voids and improve the transfer of liquid from the liquid reservoir to, for example, a vaporizer. Furthermore, the advantageous pressure described above can thereby be converted into a compression of the sponge, by which the suction and onward transport of the liquid is further facilitated.

It is further proposed that the sponge is thermally stable up to a temperature of 300° C. The proposed material property prevents the material from melting under the effect of temperature and the capillaries from melting down. Furthermore, it can prevent components of the sponge from outgassing and being added to the liquid to be vaporized.

The invention is explained below on the basis of preferred embodiments with reference to the accompanying figures. Thereby shows

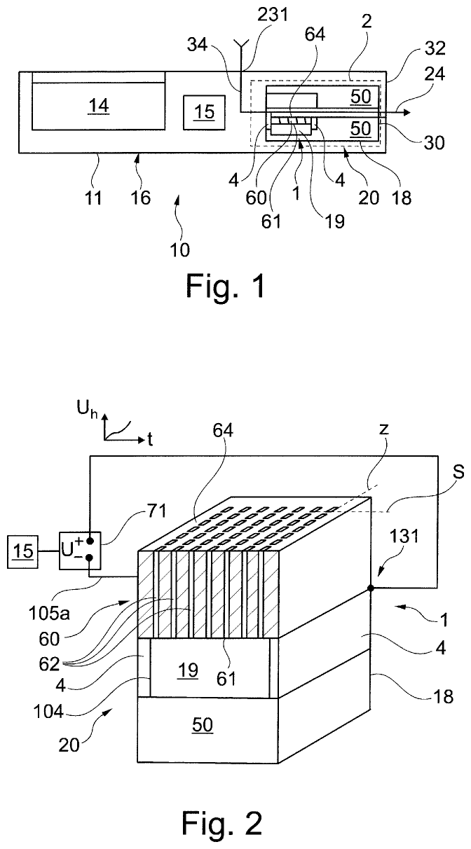

FIG. 1 a schematic view of an inhaler;

FIG. 2 a perspective section through a schematic vaporizer-tank unit;

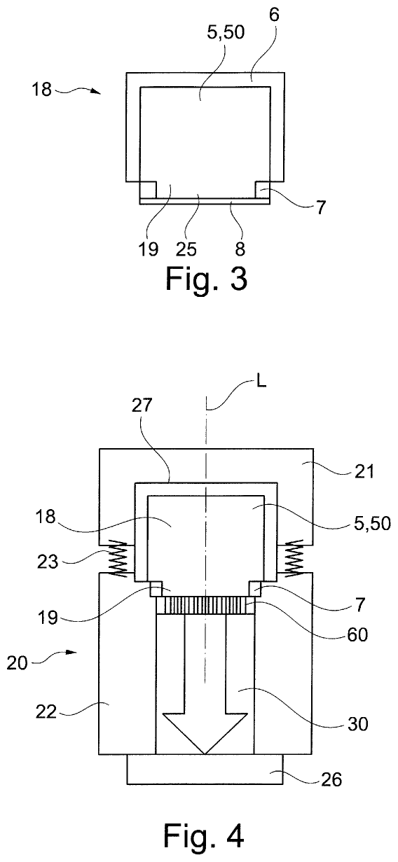

FIG. 3 a replaceable liquid reservoir as an individual part;

FIG. 4 an enlarged view of a vaporizer tank unit with a replaceable liquid reservoir.

FIG. 1 schematically shows an inhaler 10 or an electronic cigarette product. The inhaler 10 comprises a housing 11 in which an air channel 30 or vent is provided between at least one air inlet opening 231 and an air outlet opening 24 at a mouth end 32 of the cigarette product 10. The mouth end 32 of the inhaler 10 thereby denotes the end at which the consumer draws for the purpose of inhalation, thereby applying a negative pressure to the inhaler 10 and generating an air flow 34 in the air channel 30.

Advantageously, the inhaler 10 comprises a base part 16 and a vaporizer tank unit 20 that comprises a vaporizer device 1 having a vaporizer 60 and a liquid reservoir 18, which is in particular in the form of a replaceable interchangeable cartridge. The liquid reservoir 18 can be replaced by the user of the inhaler 10, for which purpose the inhaler 10 comprises a suitable closable access opening 2. The air drawn through the air inlet opening 231 is directed in the air channel 30 to the at least one vaporizer 60. The vaporizer 60 is connected or connectable to the liquid reservoir 18, in which at least one liquid 50 is stored. For this purpose, a porous and/or capillary liquid-conducting wick structure 19 is advantageously arranged at an inlet side 61 of the vaporizer 60.

The vaporizer 60 vaporizes liquid 50 supplied to the vaporizer 60 from the liquid reservoir 18 by the wick structure 19 by means of capillary forces, and adds the vaporized liquid as an aerosol/vapor to the air stream 34 at an outlet side 64.

The electronic cigarette 10 further comprises an electrical energy storage device 14 and an electronic control device 15. The energy storage device 14 is generally disposed in the base part 16 and may be, in particular, a disposable electrochemical battery or a rechargeable electrochemical battery, for example, a lithium-ion battery. The vaporizer tank unit 20 is disposed between the energy storage device 14 and the mouth end 32. The electronic control device 15 comprises at least one digital data processing device, in particular microprocessor and/or microcontroller, in the base part 16 (as shown in FIG. 1) and/or in the vaporizer tank unit 20.

Advantageously, a sensor, for example a pressure sensor or a pressure or flow switch, is arranged in the housing 11, wherein the control device 15 can determine, based on a sensor signal output by the sensor, that a consumer is drawing on the mouth end 32 of the cigarette product 10 to inhale. In this case, the control device 15 controls the vaporizer 60 to add liquid 50 from the liquid reservoir 18 as an aerosol/vapor into the air stream 34.

The at least one vaporizer 60 is arranged in a portion of the vaporizer tank unit 20 facing away from the mouth end 32. This allows for effective electrical coupling and control of the vaporizer 60, particularly with the base part 16. Advantageously, the air flow 34 passes through an air channel 30 extending axially through the liquid reservoir 18 to the air outlet opening 24.

The liquid 50 stored in the liquid reservoir 18 to be dispensed is, for example, a mixture of 1,2-propylene glycol, glycerol, water and preferably at least one aroma (flavor) and/or at least one active ingredient, in particular nicotine. However, the indicated components of the liquid 50 are not mandatory. In particular, aroma and/or active ingredients, in particular nicotine, may be omitted.

FIG. 2 shows a perspective section through a schematic vaporizer tank unit 20. The vaporizer tank unit 20 comprises a block-shaped, preferably monolithic heating body or vaporizer 60 preferably made of an electrically conductive material, in particular a semiconductor material, preferably silicon. It is not necessary that the entire vaporizer 60 be made of an electrically conductive material. It may be sufficient, for example, that the surface of the vaporizer 60 is electrically conductive, for example metallically coated or preferably suitably doped. In this case, the entire surface need not be coated; for example, metallic or preferably non-metallic or non-metallically laminated metallic conductor tracks may be provided on a non-conductive or semi-conductive base body. It is also not essential that the entire vaporizer 60 heats; for example, it may be sufficient if a section or heating layer of the vaporizer 60 heats in the region of the outlet side 64. The vaporizer 60 is heated by electrical energy based on its electrical resistance, and thus may be referred to as a resistance heater.

Advantageously, the vaporizer 60 is provided with a plurality of microchannels or fluid channels 62 that fluidly connect an inlet side 61 of the vaporizer 60 to an outlet side 64 of the vaporizer 60.

The average diameter of the liquid channels 62 is preferably in the range between 5 μm and 200 μm, further preferably in the range between 30 μm and 150 μm, still further preferably in the range between 50 μm and 100 μm. Due to these dimensions, a capillary effect is advantageously created so that liquid entering a liquid channel 62 at the inlet side 61 rises upwardly through the liquid channel 62 until the liquid channel 62 is filled with liquid. The number of liquid channels 62 is preferably in the range of four to 1000. In this way, the heat input into the liquid channels 62 can be optimized and an ensured high vaporization performance and a sufficiently large vapor outlet area can be realized.

The liquid channels 62 are advantageously arranged in the form of an array. The array can be in the form of a matrix with s columns and z rows, wherein s advantageously lies in the range between 2 and 50 and further advantageously lies in the range between 3 and 30 and/or z advantageously lies in the range between 2 and 50 and further advantageously lies in the range between 3 and 30. In this way, an effective and easily producible arrangement of the liquid channels 62 with ensured high vaporization performance can be realized.

The vaporizer tank unit 20 comprises a carrier 4 with a passage opening 104 for the liquid-conducting connection of the vaporizer 60 and a liquid reservoir 18. The carrier 4 and the vaporizer 60 are components of a vaporizer device 1, which realizes the electrical and mechanical connection of the vaporizer 60. A wick structure 19 is arranged in the passage opening 104 for supplying liquid 50 to the vaporizer 60.

The inlet side 61 of the vaporizer 60 is liquid-conductingly connected to the liquid reservoir 18 via the wick structure 19. The wick structure 19 is used to passively feed liquid 50 from the liquid reservoir 18 to the vaporizer 60 by means of capillary forces. The wick structure 19 advantageously contacts the inlet side 61 of the vaporizer 60 in a planar manner and covers all liquid channels 62 of the vaporizer 60 on the inlet side. On the side opposite the vaporizer 60, the wick structure 19 is connected to the liquid reservoir 18 in a liquid-conducting manner.

An advantageous volume of the liquid reservoir 18 is in the range between 0.1 ml and 5 ml, preferably between 0.5 ml and 3 ml, further preferably between 0.7 ml and 2 ml or 1.5 ml.

The vaporizer tank unit 20 is preferably connected and/or connectable to a heating voltage source 71 controllable by the control device 15, which is connected to the vaporizer 60 for an electrical voltage supply via electrical lines 105a, 105b in a contact area 131 at opposite edge sections of the vaporizer 60, so that an electrical voltage Uh generated by the heating voltage source 71 results in a current flow through the vaporizer 60. Due to the ohmic resistance of the electrically conductive vaporizer 60, the current flow causes heating of the vaporizer 60 and therefore vaporization of liquid contained in the liquid channels 62. Vapor/aerosol generated in this manner escapes to the outlet side 64 from the liquid channels 62 and is mixed with the air flow 34. More specifically, upon detecting an air flow 34 through the air channel 30 caused by drawing of the consumer, the control device 15 controls the heating voltage source 71, wherein the liquid contained in the liquid channels 62 is driven out of the liquid channels 62 in the form of vapor/aerosol by spontaneous heating.

The vaporization temperature is preferably in the range between 100° C. and 400° C., more preferably between 150° C. and 350° C., even more preferably between 190° C. and 290° C.

Advantageously, the vaporizer 60 may be fabricated from portions of a wafer having thin film layer technology which comprises a layer thickness preferably less than or equal to 1000 μm, further preferably 750 μm, still further preferably less than or equal to 500 μm. Surfaces of the vaporizer 60 may advantageously be hydrophilic.

The vaporizer tank unit 20 is adjusted to dispense an amount of liquid preferably in the range between 1 μl and 20 μl, further preferably between 2 μl and 10 μl, still further preferably between 3 μl and 5 μl, typically 4 μl per puff of the consumer. Preferably, the vaporizer tank unit may be adjustable with respect to the amount of liquid/vapor per puff, i.e., from 1 s to 3 s per puff duration.

The drive frequency of the vaporizer 60 generated by the heating voltage source 71 is generally advantageously in the range of 1 Hz to 50 kHz, preferably in the range of 30 Hz to 30 kHz, still more advantageously in the range of 100 Hz to 25 kHz.

The vaporizer 60 is preferably based on MEMS technology, in particular silicon, and is therefore advantageously a micro-electro-mechanical system.

In FIG. 3, the liquid reservoir 18 is shown in an enlarged view as a single component. The liquid reservoir 18 is in the form of a replaceable interchangeable cartridge and comprises a housing 6 with a hollow space 5, in which the liquid 50 is stored. The housing 6 further comprises an opening 25, which is encompassed by a seal 7 and is closed via a foil 8 bonded to the seal 7. The hollow space 5 is preferably completely filled with a sponge. However, if the hollow space 5 is not completely filled with the sponge, it is at least arranged so that it completely fills the opening 25. The sponge comprises a plurality of capillaries which are filled with the liquid and thereby form the wick structure 19 required for supplying the liquid. The sponge is preferably inherently flexible and thermally stable up to a temperature of 300° C.

FIG. 4 shows the vaporizer tank unit 20 with the liquid reservoir 18 inserted. The vaporizer tank unit 20 comprises a tubular draw member 22 having an air channel 30 provided therein and a mouthpiece 26 attached thereto. Further, the vaporizer 60 is retained in the air channel 30 of the draw member 22 such that the consumer draws air through the vaporizer 60 when the mouthpiece 26 is pulled in the direction of the arrow. Further, the vaporizer tank unit 20 comprises a pressing piece 21 which comprises a receptacle 27 in which the liquid reservoir 18 is retained. The pressing piece 21 is pulled against the pulling piece 22 by two springs 23. The two springs 23 are arranged diametrically to a longitudinal axis L of the pressing piece 21, so that the pressing piece 21 is spring-loaded in cross-section point-symmetrically to its longitudinal axis. The pressing piece is thereby spring loaded uniformly in the direction of its longitudinal axis L toward the vaporizer 60. Here, the spring-loaded pressing piece 21 forms a device by means of which the liquid reservoir 18 is pressed against the vaporizer 60. Alternatively or additionally, the pressing piece 21 could also be pressed against the vaporizer 60 by a magnetic force. The only important aspect of the pressure applying device is that the liquid reservoir 18 can be removed from the receptacle 27 and reinserted without the aid of a tool, if possible.

The liquid reservoir 18 is sealed via the foil 8 prior to use, i.e., the liquid 50 cannot unintentionally escape or outgas from the opening 25. To use the liquid reservoir 18, the foil 8 is removed and the liquid reservoir 18 is inserted into the receptacle 27, wherein insertion can be facilitated by stretching the springs 23 and enlarging the receptacle 27. The receptacle 27 is shaped in such a way that its shape determines the insertion direction of the liquid reservoir 18. The liquid reservoir 18 can thus only be inserted in such a way that it comes into contact with the free opening 25 and the seal 7 on the vaporizer 60. In doing so, the sponge, due to its inherently flexible nature, allows its surface to conform to the surface of the vaporizer 60. Furthermore, the seal 7 is also inherently flexible and is forced against the surface of the vaporizer 60 in a sealing manner by the exertion of pressure via the springs 23 so that the liquid 50 cannot escape laterally from the opening 25 without passing through the vaporizer 60. The sponge that is the wick structure 19 is lightly forced against the vaporizer 60 by the spring loading, so that reliable contact of the wick structure 19 with the vaporizer 60 is always realized with as few voids as possible. In addition, this allows the sponge to be slightly compressed, assisting in the discharge of the liquid from the capillaries and the delivery of the liquid toward the opening 25. The liquid reservoir 18 is thus in fluid communication with the vaporizer 60 in the inserted state, i.e., the liquid 50 can flow from the hollow space 5 of the liquid reservoir 18 into the vaporizer 60 via the opening 25.

### LIST OF REFERENCE SIGNS

1 vaporizer device
2 access opening
4 carrier
5 hollow space
6 housing
7 seal
8 foil
10 inhaler
11 housing
14 energy storage device
15 control device
16 base part
18 liquid reservoir
19 wick structure
20 vaporizer tank unit
21 pressing piece
22 pulling piece
23 spring
24 air outlet opening
25 opening
26 mouthpiece
27 receptable
30 air channel
32 mouth end
34 air flow
50 liquid
60 vaporizer
61 inlet side
62 liquid channel
64 outlet side
71 heating voltage source
104 passage opening
105a, 105b electrical lines
131 contact area
231 air inlet opening

1. An inhaler, comprising:
a vaporizer device, wherein the vaporizer device comprises:
at least one electrical vaporizer for vaporizing liquid supplied to the at least one electrical vaporizer,
at least one electrical line connected to an electrical voltage supply of the vaporizer, and
a receptacle for retaining a replaceable liquid reservoir, which is configured to fluidically connect to the at least one electrical vaporizer via an opening,
wherein the receptacle comprises a device which forces the replaceable liquid reservoir with the opening into direct abutment with the vaporizer.

2. The inhaler according to claim 1,
wherein a seal is provided between the at least one electrical vaporizer and the replaceable liquid reservoir sealing the opening to the outside.

3. The inhaler according to claim 1,
wherein the device comprises a clamping device actuated by a magnetic force.

4. The inhaler according to claim 1,
wherein the device comprises a spring-loaded pressing piece.

5. The inhaler according to claim 4,
wherein the spring-loaded pressing piece is spring-loaded in a direction of an intended flow direction in the inhaler.

6. The inhaler according to claim 4,
wherein the spring-loaded pressing piece is spring-loaded point-symmetrically to a longitudinal axis (L) of the spring-loaded pressing piece.

7. A replaceable liquid reservoir for an inhaler comprising:
a hollow space which is filled with at least one liquid and is releasable via an opening, and
a wick structure for transporting the at least one liquid out of the hollow space,
wherein the opening is enclosed by a seal, and is closed via a foil bonded to the seal.

8. The replaceable liquid reservoir according to claim 7,
wherein the wick structure is formed by a sponge filling at least the opening.

9. The replaceable liquid reservoir according to claim 8,
wherein the sponge completely fills the hollow space.

10. The replaceable liquid reservoir according to claim 8,
wherein the sponge is flexible in itself.

11. The replaceable liquid reservoir according to claim 8,
wherein the sponge is thermally stable up to a temperature of 300° C.
